(19) United States
(12) Patent Application Publication
(10) Pub. No.: US 2025/0086634 A1
(43) Pub. Date: Mar. 13, 2025

(54) SYSTEM AND METHOD FOR DETERMINING DATA TRANSFER FREEZES

(71) Applicant: BANK OF AMERICA CORPORATION, Charlotte, NC (US)

(72) Inventors: Rahul Yaksh, Austin, TX (US); Sailesh Vezzu, Hillsborough, NJ (US); Amer Ali, Jersey City, NJ (US); Rahul Shashidhar Phadnis, Charlotte, NC (US); Elvis Nyamwange, Little Elm, TX (US); Hari Vuppala, Concord, NC (US); Pratap Dande, Saint Johns, FL (US); Brian Neal Jacobson, Los Angeles, CA (US); Erik Dahl, Newark, DE (US)

(73) Assignee: BANK OF AMERICA CORPORATION, Charlotte, NC (US)

(21) Appl. No.: 18/243,430

(22) Filed: Sep. 7, 2023

(51) Int. Cl. G06Q 20/40

(52) U.S. Cl. CPC G06Q 20/4016; G06Q 20/4014

(57) ABSTRACT

Systems, computer program products, and methods for determining data transfer freezes are provided. The method includes receiving a freeze request from an end-point device associated with a user. The freeze request is associated with one or more connected data transfer entities and with a first account associated with the user. The freeze request is a request for a freeze of data transfers between the first account and any of the one or more connected data transfer entities. The method also includes cause a transmission of a decoy account information to a first connected data transfer entity. The decoy account information is different than an account information for the first account. The method further includes receiving a first data transfer request including the decoy account information. The method still further includes causing a rejection of the first data transfer request due to the decoy account information.

### TECHNOLOGICAL FIELD

Example embodiments of the present disclosure relate generally to managing data transfer security and, more particularly, to determining data transfer freezes.

### BACKGROUND

Data transfer credentials are often exchanged in order to process data transfers. However, such network connectivity across various entities and users can result in unauthorized data transfers due to account information being stored in various nodes of a network. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

In an example embodiment, a system for determining data transfer freezes is provided. The system includes at least one non-transitory storage device containing instructions and at least one processing device coupled to the at least one non-transitory storage device. The at least one processing device, upon execution of the instructions, is configured to receive a freeze request from an end-point device associated with a user. The freeze request is associated with one or more connected data transfer entities and a first account of one or more accounts associated with the user. The freeze request is a request for a freeze of data transfers between the first account and any of the one or more connected data transfer entities. The at least one processing device, upon execution of the instructions, is also configured to cause a transmission of a decoy account information to a first connected data transfer entity of the one or more connected data transfer entities. The decoy account information is different than an account information for the first account. The at least one processing device, upon execution of the instructions, is further configured to receive a first data transfer request associated with the first connected data transfer entity of the one or more connected data transfer entities. The first data transfer request includes the decoy account information. The at least one processing device, upon execution of the instructions, is still further configured to cause a rejection of the first data transfer request due to the decoy account information.

In various embodiments, the at least one processing device, upon execution of the instructions, is configured to receive a freeze stop indication with the freeze stop indication indicating an end to the freeze between the first account and at least one of the one or more connected data transfer entities and cause a transmission of the account information for the first account to the at least one of the one or more connected data transfer entities indicated in the freeze stop indication.

In various embodiments, the freeze request includes a freeze time period with the freeze time period indicating at least one of a starting freeze time, an ending freeze time, or freeze length for the freeze.

In various embodiments, the at least one processing device, upon execution of the instructions, is configured to determine the decoy account information with the decoy account information causing any data transfer that includes the decoy account information to be rejected. In various embodiments, the decoy account information is determined based on comparing a potential decoy account information to one or more known account information with the one or more known account information corresponding to one or more known accounts.

In various embodiments, the at least one processing device, upon execution of the instructions, is configured to cause a transmission of the decoy account information to a second connected data transfer entity of the one or more connected data transfer entities with the decoy account information being different than account information for the first account, receive a second data transfer request associated with the second connected data transfer entity of the one or more connected data transfer entities with the second data transfer request including the decoy account information; and cause a rejection of the second data transfer request due to the decoy account information.

In various embodiments, the at least one processing device, upon execution of the instructions, is configured to cause a transmission of the decoy account information to each of the one or more connected data transfer entities with the decoy account information being different than account information for the first account.

In various embodiments, the transmission of the decoy account information to the first connected data transfer entity of the one or more connected data transfer entities includes an indication to replace the account information for the first account.

In another example embodiment, a computer program product for determining data transfer freezes is provided. The computer program product includes at least one non-transitory computer-readable medium having computer-readable program code portions embodied therein. The computer-readable program code portions include one or more executable portions configured to receive a freeze request from an end-point device associated with a user. The freeze request is associated with one or more connected data transfer entities and a first account of one or more accounts associated with the user. The freeze request is a request for a freeze of data transfers between the first account and any of the one or more connected data transfer entities. The computer-readable program code portions include one or more executable portions also configured to cause a transmission of a decoy account information to a first connected data transfer entity of the one or more connected data transfer entities. The decoy account information is different than an account information for the first account. The computer-readable program code portions include one or more executable portions further configured to receive a first data transfer request associated with the first connected data transfer entity of the one or more connected data transfer entities. The first data transfer request includes the decoy account information. The computer-readable program code portions include one or more executable portions still further configured to cause a rejection of the first data transfer request due to the decoy account information.

In various embodiments, the computer-readable program code portions include one or more executable portions are also configured to receive a freeze stop indication with the freeze stop indication indicating an end to the freeze between the first account and at least one of the one or more connected data transfer entities, and cause a transmission of the account information for the first account to the at least one of the one or more connected data transfer entities indicated in the freeze stop indication.

In various embodiments, the freeze request includes a freeze time period with the freeze time period indicating at least one of a starting freeze time, an ending freeze time, or freeze length for the freeze.

In various embodiments, the computer-readable program code portions include one or more executable portions are also configured to determine the decoy account information with the decoy account information causing any data transfer that includes the decoy account information to be rejected. In various embodiments, the decoy account information is determined based on comparing a potential decoy account information to one or more known account information with the one or more known account information corresponding to one or more known accounts.

In various embodiments, the computer-readable program code portions include one or more executable portions are also configured to cause a transmission of the decoy account information to a second connected data transfer entity of the one or more connected data transfer entities with the decoy account information being different than account information for the first account, receive a second data transfer request associated with the second connected data transfer entity of the one or more connected data transfer entities with the second data transfer request including the decoy account information, and cause a rejection of the second data transfer request due to the decoy account information.

In various embodiments, the computer-readable program code portions include one or more executable portions are also configured to cause a transmission of the decoy account information to each of the one or more connected data transfer entities with the decoy account information being different than account information for the first account.

In various embodiments, the transmission of the decoy account information to the first connected data transfer entity of the one or more connected data transfer entities includes an indication to replace the account information for the first account.

In still another example embodiment, a method for determining data transfer freezes is provided. The method includes receiving a freeze request from an end-point device associated with a user. The freeze request is associated with one or more connected data transfer entities and a first account of one or more accounts associated with the user. The freeze request is a request for a freeze of data transfers between the first account and any of the one or more connected data transfer entities. The method also includes causing a transmission of a decoy account information to a first connected data transfer entity of the one or more connected data transfer entities. The decoy account information is different than an account information for the first account. The method further includes receiving a first data transfer request associated with the first connected data transfer entity of the one or more connected data transfer entities. The first data transfer request includes the decoy account information. The method still further includes causing a rejection of the first data transfer request due to the decoy account information.

In various embodiments, the method also includes receiving a freeze stop indication with the freeze stop indication indicating an end to the freeze between the first account and at least one of the one or more connected data transfer entities and causing a transmission of the account information for the first account to the at least one of the one or more connected data transfer entities indicated in the freeze stop indication.

In various embodiments, the method also includes determining the decoy account information with the decoy account information causing any data transfer that includes the decoy account information to be rejected. In various embodiments, the decoy account information is determined based on comparing a potential decoy account information to one or more known account information with the one or more known account information corresponding to one or more known accounts.

In various embodiments, the method also includes causing a transmission of the decoy account information to a second connected data transfer entity of the one or more connected data transfer entities with the decoy account information being different than account information for the first account, receiving a second data transfer request associated with the second connected data transfer entity of the one or more connected data transfer entities with the second data transfer request including the decoy account information, and causing a rejection of the second data transfer request due to the decoy account information.

In various embodiments, the method also includes causing a transmission of the decoy account information to each of the one or more connected data transfer entities with the decoy account information being different than account information for the first account.

In various embodiments, the transmission of the decoy account information to the first connected data transfer entity of the one or more connected data transfer entities includes an indication to replace the account information for the first account.

The features, functions, and advantages that have been discussed may be achieved independently in various embodiments of the present disclosure or may be combined with yet other embodiments, further details of which can be seen with reference to the following description and drawings.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate technical components of an example distributed computing environment for determining data transfer freezes, in accordance with various embodiments of the present disclosure; and

FIG. 2 illustrates a process flow for determining data transfer freezes, in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the various inventions may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers, or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Unauthorized data transfers (e.g., resources transfers) may be initiated without request and/or approval of the party involved. For example, unauthorized transfers on a peer-to-peer payment network may be initiated by a third-party, who effectively takes the resource of a user without user approval. Data transfers have been greater improved in terms of speed as storing account information over different network nodes has allowed for real-time or near real-time data transfers. However, as the amount of different network entities (e.g., payment networks, merchants, peer-to-peer networks, etc.) receive access to account information, user security is reduced.

Various embodiments of the present disclosure allow for determining data transfer freezes. As such, third party access to user accounts can be drastically reduced without completely freezing user accounts. To do this, the system may receive a freeze request from an end-point device associated with a user. The freeze request is associated with one or more connected data transfer entities and with a first account of one or more accounts associated with the user. As such, the freeze request is a request for a freeze of data transfers between the first account and any of the one or more connected data transfer entities. To implement the freeze, the system provides decoy account information to each of the connected data transfer entities included in the freeze request. The decoy account information is intended to replace the first account information currently possessed by the connected data transfer entities. As such, any future resource transfer requests by the connected data transfer entities that include the decoy account information will be rejected. As such, the system allows for improved data security without causing any delays in data transfers. Various embodiments specifically improve data security and processing. Namely, the present disclosure allows for improved data security without any reduction in processing speed. The operations of data processing remain unchanged, while reducing the amount of unauthorized data transfers.

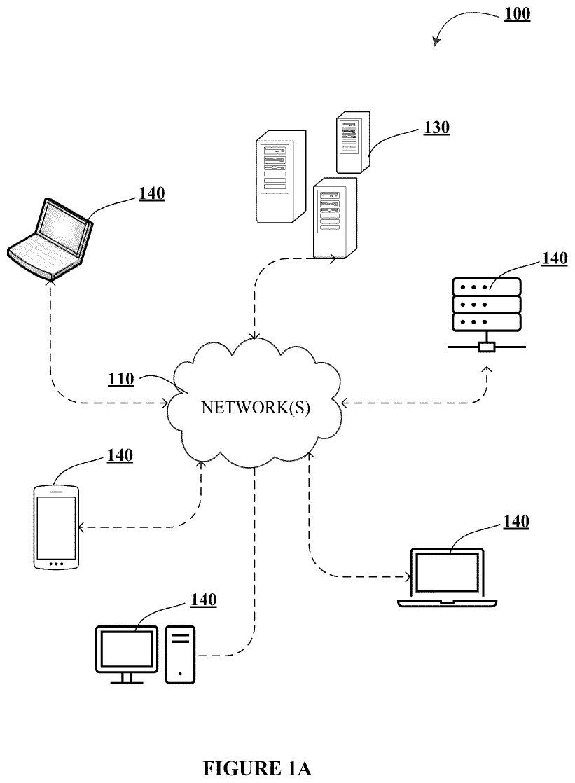

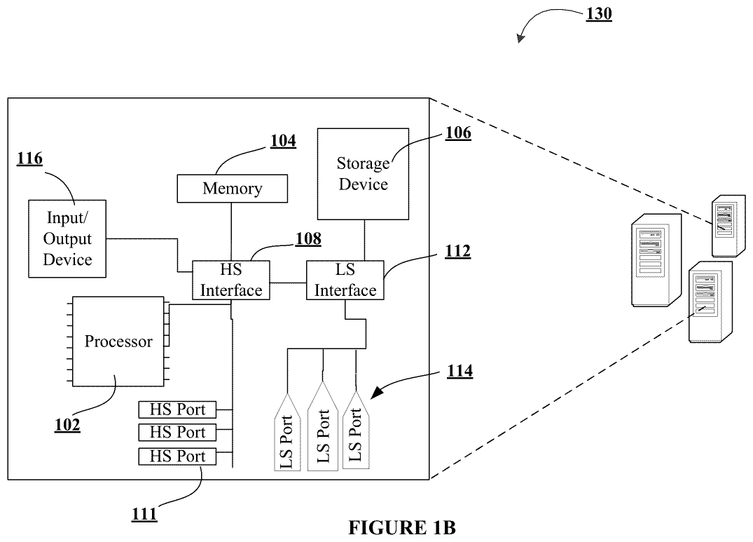

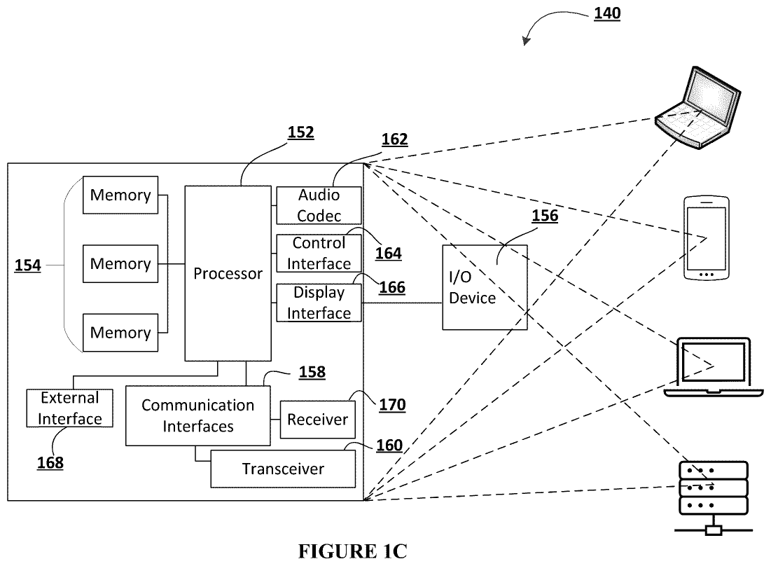

FIGS. 1A-1C illustrate technical components of an exemplary distributed computing environment for determining data transfer freezes, in accordance with various embodiments of the disclosure. As shown in FIG. 1A, the distributed computing environment 100 contemplated herein may include a system 130 (e.g., a data transfer freezing device), an end-point device(s) 140, and one or more networks 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system). In various embodiments, the plurality of verification nodes may be part of the system 130, one or more end-point devices, and/or other devices connected to the network(s) 110.

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network(s) 110. Instead of having a central server (e.g., system 130) which would act as the shared drive, each device that is connect to the network(s) 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network(s) 110 may be a distributed network that is spread over different networks. This provides a single data communication network, which can be managed jointly or separately by each network. Besides shared communication within the network, the distributed network often also supports distributed processing. The network(s) 110 may be a form of digital communication network such as a telecommunication network, a local area network (“LAN”), a wide area network (“WAN”), a global area network (“GAN”), the Internet, satellite network, cellular network, and/or any combination of the foregoing. The network(s) 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosure described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low-speed expansion port 114 (shown as “LS Port”) and storage device 106. Each of the components 102, 104, 106 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interfaces 158, and a transceiver 160, among other components. The end-point device(s) 140 may also be provided with a storage device, such as a micro-drive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single in Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network(s) 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through at least one of communication interfaces 158, which may include digital signal processing circuitry where necessary. Communication interfaces 158 may provide for communications under various modes or protocols, such as the Internet Protocol (IP) suite (commonly known as TCP/IP). Protocols in the IP suite define end-to-end data handling methods for everything from packetizing, addressing, and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interfaces 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130. The end-point device(s) 140 may include a communication interface that is configured to operate with a satellite network.

In various embodiments, the end-point device(s) 140 may have multiple communication interfaces that are configured to operate using the various communication methods discussed herein. For example, an end-point device 140 may have a cellular network communication interface (e.g., a communication interface that provides for communication under various telecommunications standards) and a satellite network communication interface (e.g., a communication interface that provides for communication via a satellite network). Various other communication interfaces may also be provided by the end-point device (e.g., an end-point device may be capable of communicating via a cellular network, a satellite network, and/or a wi-fi connection). Various communication interfaces may share components with other communication interfaces in the given end-point device.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

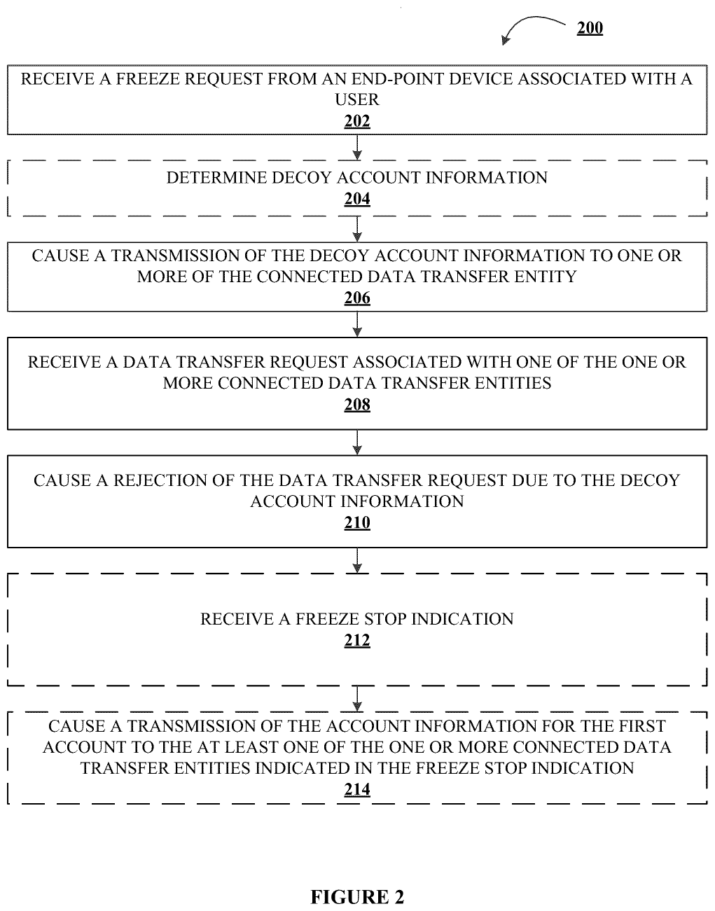

FIG. 2 includes a flow chart 200 that illustrates an example method for determining data transfer freezes. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein. A method of various embodiments may include any combination or subset of the features discussed herein.

Referring now to Block 202 of FIG. 2, the method includes receiving a freeze request from an end-point device associated with a user. The freeze request may be associated with one or more accounts associated with the user. The user may select which accounts a freeze request applies. For example, a freeze request may apply to a first account associated with the user and not to other accounts associated with the user. In various embodiments, the freeze request may be a request for a freeze of data transfers (e.g., resource transfers) between one or more accounts associated with the user (e.g., a first account) and any of the one or more connected data transfer entities.

In various embodiments, the freeze request may be associated with one or more connected data transfer entities. A connected data transfer entity may be any entity and/or user that has previously been provided account information for one or more accounts associated with the user. As such, a connected data transfer entity may be a merchant, a peer-to-peer payment network, a user of a peer-to-peer payment network, third-party payment network, and/or the like. A connected data transfer entity may be provided the account information by the user (e.g., via a purchase or otherwise), a payment network entity, a financial institution (e.g., a financial institution may provide account information upon approval of the user), and/or the like. As such, a connected data transfer entity may be any entity and/or user that has received account information for one or more account associated with the user. As discussed herein, the connected data transfer entities included in a freeze request may be selected by the user (e.g., the user may select connected data transfer entities from a list of data transfer entities that have received account information). In various embodiments, one or more of the connected data transfer entities in a freeze request may be identified by the system (e.g., the system may identify potential threats).

In various embodiments, the freeze request may be completed by the user via a system portal (e.g., a user interface rendered on an end-point device associated with the user). The system portal may allow a user to select the one or more connected data transfer entities that are included in the freeze request. As such, one or more data transfer entities that have been previously provided information relating to the user account (e.g., account number, routing information, and/or the like) may be provided to the user to select the connected data transfer entities included in the freeze request. For example, the user may select the connected data transfer entities from a list of data transfer entities that have previously received information relating to the user and/or user account. Additionally or alternatively, the freeze request may identify the connected data transfer entities in various other ways, such as data transfer entities that have not has any data transfers with the account(s) of the user for a predetermined amount of time, specifically identified data transfer entities (e.g., manually identified), and/or the like.

In various embodiments, the freeze request is a request for a freeze of data transfers between the selected account(s) associated with the user (e.g., a first account associated with the user) and any of the one or more connected data transfer entities. In various embodiments, the freeze request may be directed for one or more accounts associated with the user. As such, the freeze request may apply to less than all of the accounts associated with the user, allowing for other accounts associated with a user to be unaffected.

In various embodiments, the freeze request may be indefinite (e.g., no end time for the requested freeze). Alternatively, the freeze request may include a freeze time period. A freeze time period may be indicated in various ways, such as a starting freezing time (e.g., freeze to start immediately or at some point in future), an ending freeze time (e.g., a time at which the freeze is ended), and/or a freeze length (e.g., amount of time in which the freeze is extended. In various embodiments, at the end of a freeze time period, the system may carry out the operations discussed in reference to optional Block 214.

Referring now to optional Block 204 of FIG. 2, the method includes determining decoy account information. The decoy account information may be an account number or other account routing information that causes a resource transfer to be rejected. As such, the decoy account information may be directed to an account that does not exist (e.g., an account number of 000000-0000-0000-00) or an account that does not have any resources (e.g., an account that has no resources, such that any resource transfer request is rejected). As such, the decoy account information causes any data transfer that includes the decoy account information to be rejected.

In various embodiments, the same decoy account information may be transmitted to each of the connected data transfer entities. Alternatively, multiple different decoy account information sets may be used for different connected data transfer entities. In various embodiments, decoy account information may be used for multiple accounts for the same user and/or account(s) associated with other users (e.g., the same decoy account information may be used for multiple different user accounts). Alternatively, the decoy account information may be assigned to a specific user and/or specific account associated with the user for tracking purposes (e.g., decoy account information may be monitored to determine whether any data transfer requests are using the decoy account information).

In various embodiments, the decoy account information may be determined based on comparing a potential decoy account information to one or more known account information. In various embodiments, the system may generate one or more potential decoy account information sets, which each include potential decoy account information. The potential decoy account information is then compared to known account information corresponding to known account(s) (e.g., accounts of other users on a network) to confirm that no known accounts have the same information. As such, the system confirms that a potential decoy account information would not route a data transfer to a different known account. For example, the system may generate a decoy account number and confirm that no other accounts on the network have the same account number.

Referring now to Block 206 of FIG. 2, the method includes causing a transmission of the decoy account information to one or more of the connected data transfer entity (e.g., a first connected data transfer entity of the one or more connected data transfer entities, a second connected data transfer entity of the one or more connected data transfer entities, a third connected data transfer entity of the one or more connected data transfer entities, etc.). In various embodiments, the decoy account information is different than an account information for the first account (or any of the accounts associated with the user).

The transmission of the decoy account information may include an indication to replace the first account information currently stored by the given connected data transfer. For example, since a connected data transfer entity has been provided access to the first account information, the connected data transfer entity may store said first account information for future data transfers. The transmission of the decoy account information includes an indication that the first account information has changed and that the decoy account information is to replace the first account information.

Referring now to Block 208 of FIG. 2, the method includes receiving a data transfer request (e.g., a first data transfer request, a second data transfer request, a third data transfer request, etc.) associated with one of the one or more connected data transfer entities (e.g., the first connected data transfer entity of the one or more connected data transfer entities, the second connected data transfer entity of the one or more connected data transfer entities, the third connected data transfer entity of the one or more connected data transfer entities, etc.).

In various embodiments, the data transfer request (e.g., the first data transfer request) may include decoy account information (e.g., in an instance in which the first connected data transfer entity is attempting to complete a data transfer with the first account). The data transfer request, other than containing the decoy account information, may include any of the typical information included in a data transfer request (e.g., data transfer amount, involved parties, time of execution, etc.). As such, the data transfer request including the decoy account information can be processed in the same way that other data transfer requests are processed and then be rejected, as discussed in reference to Block 210 below.

Referring now to Block 210 of FIG. 2, the method includes causing a rejection of the data transfer request (e.g., the first data transfer request associated with the first connected data transfer entity, the second data transfer request associated with the second connected data transfer entity, the third data transfer request associated with the third connected data transfer entity, etc.) due to the decoy account information.

In various embodiments, any data transfer request that includes decoy account information is rejected. In an example embodiment in which the decoy account information included information for a non-existent account (e.g., a decoy account number of 000000-0000-0000-00), any data transfer request with the decoy account information will be rejected due to the decoy account not being found (e.g., the system may execute the data transfer as usual, but will not be able to find the account associated with the decoy account information and provide a rejection in response). In an example embodiment in which the decoy account information included information for an actual account that is not capable of executing any data transfers (e.g., an account with no resources), any data transfer request with the decoy account information will be rejected due to lack of resources. As such, the data transfer processing operations remain the same as before and the system does not have to monitor for any decoy account information (e.g., any data transfer request with decoy account information is automatically rejected).

In various embodiments, any data transfers that include decoy account information may cause a transmission to be provided to the user (e.g., via an end-point device associated with the user). The transmission may be notification (e.g., a message notifying the user that a data transfer was attempted with one of the connected data transfer entities). Additionally or alternatively, the transmission may be a confirmation request (e.g., confirming with the user that the data transfer request was desired to be rejected). In such an instance, the user may provide a confirmation that the data transfer request should have been rejected or indicate that the data transfer request was appropriate (e.g., a user may have a freeze on an account, but still desire to make a one-off data transfer with the connected data transfer entity). As such, the system may allow the data transfer request to be executed and/or allow future data transfer requests from the same connected data transfer entity to be executed.

Referring now to optional Block 212 of FIG. 2, the method includes receiving a freeze stop indication. In various embodiments, the freeze stop indication indicates an end to the freeze between the first account and at least one of the one or more connected data transfer entities. The freeze stop indication may be included in the freeze request (e.g., the freeze request may have a freeze time period included that indicates the end of the freeze for one or more of the connected data transfer entities). Additionally or alternatively, the freeze stop indication may be received during the freeze in order to end the freeze for one or more of the connected data transfer entities. In various embodiments, the freeze stop indication may be a complete freeze stop, indicating that the freeze should stop for all of the connected data transfer entities. Alternatively, the freeze stop indication may be directed to one or more connected data transfer entities (e.g., desiring an end to the freeze with some connected data transfer entities and not with other connected data transfer entities).

In various embodiments, the at least one of the one or more connected data transfer entities indicated in the freeze stop indication may be provided with the first account information (e.g., as discussed in reference to Block 214). Alternatively, the system may provide the first account information to the at least one of the one or more connected data transfer entities indicated in the freeze stop indication once the user initiates a new data transfer with a given connected data transfer entity.

Referring now to optional Block 214 of FIG. 2, the method includes causing a transmission of the account information for the first account to the at least one of the one or more connected data transfer entities indicated in the freeze stop indication. In various embodiments, upon determining the at least one of the one or more connected data transfer entities indicated in the freeze stop indication, the system may provide one or more of the at least one of the one or more connected data transfer entities indicated in the freeze stop indication with the first account information (e.g., to replace the decoy account information).

As will be appreciated by one of ordinary skill in the art, various embodiments of the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications, and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

What is claimed is:

1. A system for determining data transfer freezes, the system comprising:
at least one non-transitory storage device containing instructions; and
at least one processing device coupled to the at least one non-transitory storage device, wherein the at least one processing device, upon execution of the instructions, is configured to:
receive a freeze request from an end-point device associated with a user, wherein the freeze request is associated with one or more connected data transfer entities, wherein the freeze request is associated with a first account of one or more accounts associated with the user, wherein the freeze request is a request for a freeze of data transfers between the first account and any of the one or more connected data transfer entities;
cause a transmission of a decoy account information to a first connected data transfer entity of the one or more connected data transfer entities, wherein the decoy account information is different than an account information for the first account;
receive a first data transfer request associated with the first connected data transfer entity of the one or more connected data transfer entities, wherein the first data transfer request comprises the decoy account information; and
cause a rejection of the first data transfer request due to the decoy account information.

2. The system of claim 1, wherein the at least one processing device, upon execution of the instructions, is configured to receive a freeze stop indication, wherein the freeze stop indication indicates an end to the freeze between the first account and at least one of the one or more connected data transfer entities; and cause a transmission of the account information for the first account to the at least one of the one or more connected data transfer entities indicated in the freeze stop indication.

3. The system of claim 1, wherein the freeze request comprises a freeze time period, wherein the freeze time period indicates at least one of a starting freeze time, an ending freeze time, or freeze length for the freeze.

4. The system of claim 1, wherein the at least one processing device, upon execution of the instructions, is configured to determine the decoy account information, wherein the decoy account information causes any data transfer that includes the decoy account information to be rejected.

5. The system of claim 4, wherein the decoy account information is determined based on comparing a potential decoy account information to one or more known account information, wherein the one or more known account information corresponds to one or more known accounts.

6. The system of claim 1, wherein the at least one processing device, upon execution of the instructions, is configured to:
cause a transmission of the decoy account information to a second connected data transfer entity of the one or more connected data transfer entities, wherein the decoy account information is different than account information for the first account;
receive a second data transfer request associated with the second connected data transfer entity of the one or more connected data transfer entities, wherein the second data transfer request comprises the decoy account information; and
cause a rejection of the second data transfer request due to the decoy account information.

7. The system of claim 1, wherein the at least one processing device, upon execution of the instructions, is configured to cause a transmission of the decoy account information to each of the one or more connected data transfer entities, wherein the decoy account information is different than account information for the first account.

8. The system of claim 1, wherein the transmission of the decoy account information to the first connected data transfer entity of the one or more connected data transfer entities includes an indication to replace the account information for the first account.

9. A computer program product for determining data transfer freezes, the computer program product comprising at least one non-transitory computer-readable medium having computer-readable program code portions embodied therein, the computer-readable program code portions comprising one or more executable portions configured to:
receive a freeze request from an end-point device associated with a user, wherein the freeze request is associated with one or more connected data transfer entities, wherein the freeze request is associated with a first account of one or more accounts associated with the user, wherein the freeze request is a request for a freeze of data transfers between the first account and any of the one or more connected data transfer entities;
cause a transmission of a decoy account information to a first connected data transfer entity of the one or more connected data transfer entities, wherein the decoy account information is different than an account information for the first account;
receive a first data transfer request associated with the first connected data transfer entity of the one or more connected data transfer entities, wherein the first data transfer request comprises the decoy account information; and
cause a rejection of the first data transfer request due to the decoy account information.

10. The computer program product of claim 9, wherein the computer-readable program code portions comprising one or more executable portions are also configured to receive a freeze stop indication, wherein the freeze stop indication indicates an end to the freeze between the first account and at least one of the one or more connected data transfer entities; and cause a transmission of the account information for the first account to the at least one of the one or more connected data transfer entities indicated in the freeze stop indication.

11. The computer program product of claim 9, wherein the freeze request comprises a freeze time period, wherein the freeze time period indicates at least one of a starting freeze time, an ending freeze time, or freeze length for the freeze.

12. The computer program product of claim 9, wherein the computer-readable program code portions comprising one or more executable portions are also configured to determine the decoy account information, wherein the decoy account information causes any data transfer that includes the decoy account information to be rejected, wherein the decoy account information is determined based on comparing a potential decoy account information to one or more known account information, wherein the one or more known account information corresponds to one or more known accounts.

13. The computer program product of claim 9, wherein the computer-readable program code portions comprising one or more executable portions are also configured to:
cause a transmission of the decoy account information to a second connected data transfer entity of the one or more connected data transfer entities, wherein the decoy account information is different than account information for the first account;
receive a second data transfer request associated with the second connected data transfer entity of the one or more connected data transfer entities, wherein the second data transfer request comprises the decoy account information; and
cause a rejection of the second data transfer request due to the decoy account information.

14. The computer program product of claim 9, wherein the computer-readable program code portions comprising one or more executable portions are also configured to cause a transmission of the decoy account information to each of the one or more connected data transfer entities, wherein the decoy account information is different than account information for the first account.

15. The computer program product of claim 9, wherein the transmission of the decoy account information to the first connected data transfer entity of the one or more connected data transfer entities includes an indication to replace the account information for the first account.

16. A method for determining data transfer freezes, the method comprising:
receiving a freeze request from an end-point device associated with a user, wherein the freeze request is associated with one or more connected data transfer entities, wherein the freeze request is associated with a first account of one or more accounts associated with the user, wherein the freeze request is a request for a freeze of data transfers between the first account and any of the one or more connected data transfer entities;
causing a transmission of a decoy account information to a first connected data transfer entity of the one or more connected data transfer entities, wherein the decoy account information is different than an account information for the first account;
receiving a first data transfer request associated with the first connected data transfer entity of the one or more connected data transfer entities, wherein the first data transfer request comprises the decoy account information; and
causing a rejection of the first data transfer request due to the decoy account information.

17. The method of claim 16, further comprising receiving a freeze stop indication, wherein the freeze stop indication indicates an end to the freeze between the first account and at least one of the one or more connected data transfer entities; and causing a transmission of the account information for the first account to the at least one of the one or more connected data transfer entities indicated in the freeze stop indication.

18. The method of claim 16, further comprising determining the decoy account information, wherein the decoy account information causes any data transfer that includes the decoy account information to be rejected, wherein the decoy account information is determined based on comparing a potential decoy account information to one or more known account information, wherein the one or more known account information corresponds to one or more known accounts.

19. The method of claim 16, further comprising causing a transmission of the decoy account information to each of the one or more connected data transfer entities, wherein the decoy account information is different than account information for the first account.

20. The method of claim 16, wherein the transmission of the decoy account information to the first connected data transfer entity of the one or more connected data transfer entities includes an indication to replace the account information for the first account.
